(19) United States
(12) Patent Application Publication
(10) Pub. No.: US 2006/0199271 A1
(43) Pub. Date: Sep. 7, 2006

(54) Temperature feedback control for solid state gas sensors

(76) Inventors: Ming-Ren Lian, Boca Raton, FL (US); Jianwei Gong, Orlando, FL (US); Nen-Chin Liu, Wellington, FL (US); Claude Daoust, Lake Worth, FL (US); Quanfang Chen, Orlando, FL (US)

Correspondence Address: IP LEGAL DEPARTMENT;TYCO FIRE & SECURITY SERVICES, ONE TOWN CENTER ROAD, BOCA RATON, FL, 33486, US

(21) Appl. No.: 11/074,385

(22) Filed: Mar. 7, 2005

(51) Int. Cl. G01N 21/72

(52) U.S. Cl. 436/155

(57) ABSTRACT

A solid state gas sensor may include gas sensing element coupled to a substrate. The gas sensing element may have a desired operating temperature, which may be between 100 and 400 degrees Celsius. The sensor may further include a temperature sensor coupled to the substrate and configured to sense an operating temperature of the sensing element and provide a feedback signal representative of the operating temperature. The sensor may further include a heater having a heat output. The heater may be responsive to the feedback signal to adjust the heat output to drive the operating temperature to the desired operating temperature. A detector such as a smoke detector or carbon monoxide detector having such a solid state gas sensor is also provided. An associated method is also provided.

### FIELD OF THE INVENTION

This disclosure relates to gas sensors, and in particular, to solid state gas sensors.

### BACKGROUND OF THE INVENTION

Solid state gas sensors may be utilized to sense a variety of gases including, but not limited to, combustible gases (e.g., propane, methane, and hydrogen), toxic gases (e.g., carbon monoxide, ammonia, and hydrogen sulfide), organic solvents (e.g., toluene and xylene) and other gases. Solid state gas sensors may also be utilized in a variety of systems and devices. Some devices may include a smoke detector and a carbon monoxide detector. Some solid state gas sensors may be used in an industrial environment to sense and provide notification of potentially dangerous conditions due to the presence of particular toxic gas such as hydrogen sulfide. Other solid state gas sensors may be utilized in an air stream of an industrial process.

The sensing element of the solid state gas sensor may be a metal oxide semiconductor which has a relatively high resistance and low conductivity in clean air. In the presence of the particular gas, the electrical resistance of the sensing element may decrease and its conductivity may increase by an amount dependent on the concentration of gas in the air. The conductivity may change in response to a chemical reaction in the sensing element. A circuit may then be utilized to convert the change in conductivity to an output signal corresponding to the concentration of gas in the air.

In general, solid state gas sensors have a relatively long lifetime, are maintenance free, have a relatively low cost, and have a fast response and recovery time. However, the sensitivity of a solid state gas sensor may be affected by changes in ambient temperature and relative humidity. This may then lead to inaccurate gas readings and even false alarm conditions. One conventional method of compensating for changes in ambient temperature is to analyze the sensitivity of the gas sensor with respect to ambient temperature changes. A circuit including a thermistor external to the solid state gas sensor may then be utilized to compensate for ambient temperature changes by changing a reference voltage comparison level. A drawback with the conventional compensation method is that the internal operating temperature of the solid state gas sensor is not maintained at a near constant level. Precision of the solid state gas sensor is therefore degraded. Another drawback is the need to develop a resistance-temperature curve to perform such compensation.

Accordingly, there is a need for a temperature compensated solid state gas sensor to compensate for ambient temperature variations by driving the operating temperature of the solid state gas sensor to a desired operating temperature. Sensitivity of the solid state gas sensor may therefore be stabilized over a range of ambient temperature thereby maintaining precision of the solid state gas sensor over the range of ambient temperatures.

### BRIEF DESCRIPTION OF THE DRAWINGS

Features and advantages of embodiments of the claimed subject matter will become apparent as the following Detailed Description proceeds, and upon reference to the Drawings, where like numerals depict like parts, and in which:

FIG. 1 is a block diagram of one system embodiment;

FIG. 2 is a block diagram of one embodiment of the solid state gas sensor of the detector of FIG. 1;

FIG. 3 is a graph illustrating operation of the solid state gas sensor of FIG. 2;

FIG. 4 is a perspective view of one embodiment of a solid state gas sensor consistent with FIGS. 2 and 3;

FIG. 5 is a block diagram of one fabrication process for the sensor of FIG. 4;

FIG. 6 is a circuit diagram of one embodiment of a temperature feedback control circuit;

FIG. 7 is a graph illustrating operation of the embodiment of FIG. 4 having the temperature feedback control circuit of FIG. 6;

FIG. 8 is another graph further illustrating operation of the embodiment of FIG. 4 having the temperature feedback control circuit of FIG. 6; and

FIG. 9 is a flow chart illustrating operations according to an embodiment.

Although the following Detailed Description will proceed with reference being made to illustrative embodiments, many alternatives, modifications, and variations thereof will be apparent to those skilled in the art. Accordingly, it is intended that the claimed subject matter be viewed broadly.

### DETAILED DESCRIPTION

For simplicity and ease of explanation, various embodiments in connection with solid state gas sensors will be described herein. It is to be understood, however, that the embodiments described herein are presented by way of illustration, not of limitation.

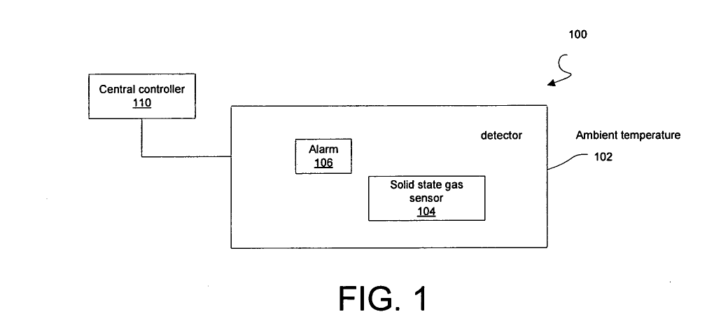

FIG. 1 is a block diagram of a system 100 including a detector 102 that may utilize a solid state gas sensor 104, e.g., a semiconductor metal oxide (SMO) gas sensor. The solid state gas sensor 104 consistent with an embodiment detailed herein may have internal temperature feedback control to drive the operating temperature of a gas sensing element of the solid state gas sensor to a desired level. The operating temperature may be affected by the ambient temperature about the detector 102.

The detector 102 may be provided in any configuration such as a smoke detector or carbon monoxide detector. The detector 102 may be utilized in a variety of environments such as residential, commercial, or industrial environments and may be mounted in selected areas of such environments. The detector 102 may be a stand-alone device having an alarm 106 that may be an audio and/or visual alarm that is activated when the solid state gas sensor 104 detects a threshold concentration level of a particular gas. The detector 102 may also-communicate via a direct or wireless connection with a central controller 110 of a building safety system, for example, to exchange data relating to a condition of the detector 102.

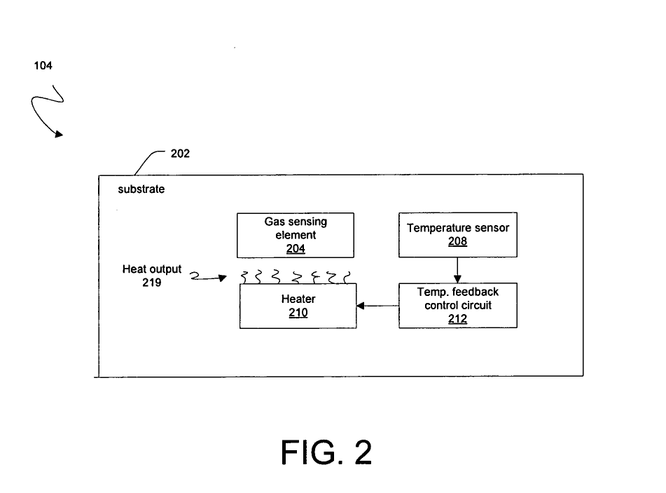

FIG. 2 illustrates a block diagram of the solid state gas sensor 104 used in the detector 102 of FIG. 1. The solid state gas sensor 104 may include a substrate 202, a gas sensing element 204, a temperature sensor 208, and a heater 210. The substrate 202 may be a variety of materials such as an alumina wafer for thermal and electrical isolation purposes or a silicon wafer. The gas sensing element 204 may include a metal oxide material such as tin oxide (SnO₂). The gas sensing element 204 may be designed to operate at a particular desired operating temperature. This desired operating temperature may vary with each gas sensing element and application but may be between 100 to 400 degrees Celsius in one embodiment. At this desired operating temperature, the gas sensing element 204 has a particular electrical resistance in the presence of clean air. In the presence of a particular gas, the electrical resistance of the gas sensing element 204 may decrease and its conductivity may increase by an amount dependent on the concentration of the gas in the air. This change in resistance and conductivity may occur in response to a chemical reaction in the gas sensing element 204. A circuit (not illustrated) may then be utilized to convert the change in conductivity to an output signal corresponding to the concentration of gas in the air as in known to those skilled in the art.

The temperature sensor 208 may be coupled to the substrate and may be configured to sense an operating temperature of the gas sensing element 204. As used herein, “coupled to” may mean directly or indirectly coupled thereto through one or more layers or components. The temperature sensor 208 may be a variety of temperature sensors such as a platinum (Pt) temperature sensor. The temperature sensor 208 may provide a feedback signal that is representative of the sensed operating temperature.

A heater 210 may provide a heat output 219 responsive to the feedback signal representative of the operating temperature in order to drive the operating temperature to the desired operating temperature. The operating temperature may vary with various conditions such as the ambient temperature about the associated system such as the detector 102. A temperature feedback control circuit 212 may be coupled to the temperature sensor 208 and heater 210 to accept the feedback signal from the temperature sensor 208 and to adjust the heat output from the heater 210 in response thereto until a desired operating temperature is reached. The temperature feedback control circuit 212 may be integrated onto the substrate 202 or may be external to the substrate 202. The heater 210 may be a type that adjusts its heat output 219 in response to a current level of the heater. In this instance, the temperature feedback control circuit 212 may be utilized to adjust the current level of the heater 210 in response to the operating temperature of the sensing element 204 as measure by the temperature sensor 208.

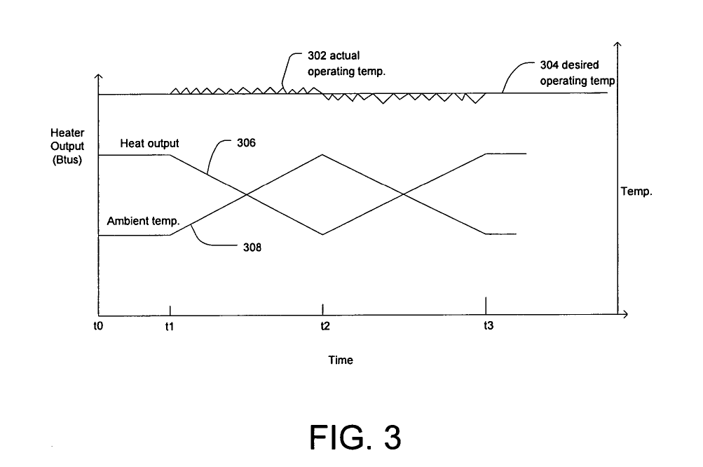

FIG. 3 includes several plots illustrating operation of the solid state gas sensor 104 of FIG. 2 and illustrating how the heat output of the heater 210 adjusts to drive the operating temperature of the gas sensing element 204 to the desired operating temperature. The operating temperature of the gas sensing element 204 may be affected by the ambient temperature about the associated system such as the detector 102. During the time interval between times t0 and t1, the ambient temperature as represented by plot 308 may remain constant and, in response, the heat output as represented by plot 306 may also remain constant. The actual and desired operating temperature as represented by plots 302 and 304 respectively may remain approximately equal during this time interval.

During the time interval between time t1 and t2, the ambient temperature may increase. As a result, the actual operating temperature may also increase above the desired operating temperature. In response to the increase in operating temperature, the heat output may decrease to drive the actual operating temperature back to the desired operating temperature. During the time interval between times t2 and t3, the ambient temperature may decrease. As a result, the actual operating temperature may also decrease below the desired operating temperature. In response to the decrease in operating temperature, the heat output may increase to drive the actual operating temperature to the desired operating temperature.

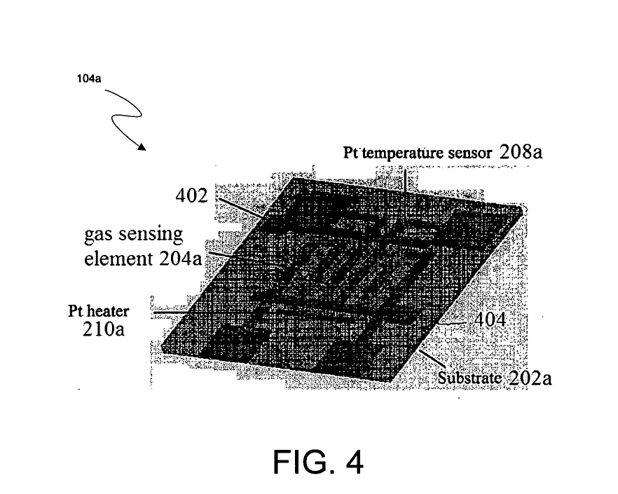

FIG. 4 illustrates a perspective view of one embodiment of a solid state gas sensor 104a consistent with the embodiment of FIG. 2 and operation as detailed in FIG. 3. The solid state gas sensor 104a may include a substrate 202a, a gas sensing element 204a, a platinum temperature sensor 208a, a platinum heater 210a, and electrodes 402, 404 which may be utilized to measure the resistance change of the gas sensing element 204a and to communicate that information to other circuitry. A temperature feedback control circuit (not illustrated), may be coupled to the platinum temperature sensor 208a and to the platinum heater 210a to accept a feedback signal from the platinum temperature sensor 208a representative of an operating temperature and to adjust a heat output from the platinum heater 210a to drive the operating temperature to the desired operating temperature. The platinum temperature sensor 208a may be located in proximity to the gas sensing element 204a in order to monitor the operating temperature of the sensing element. Although the platinum heater 210a is illustrated as having an area less than the gas sensing element 204a, the platinum heater 210a may alternatively have an area as large as, or larger than, the gas sensing element 204a to assist with providing an even thermal distribution to the gas sensing element 204a.

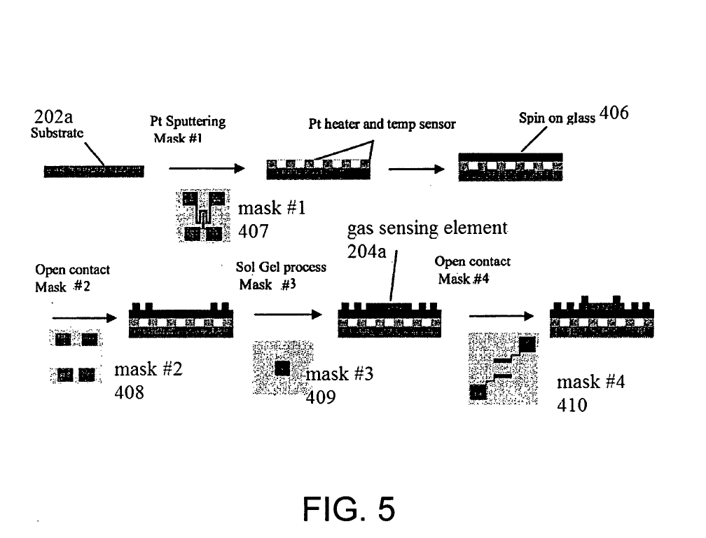

FIG. 5 illustrates one exemplary fabrication process for the solid state gas sensor 104a of FIG. 4. The substrate 202a may be positioned to receive the platinum heater 210a and platinum temperature sensor 208a to be disposed thereon. The substrate 202 may be made of a variety of material such as alumina for thermal and electrical isolation purposes. Alternatively to alumina, the substrate 202a may be silicon. The solid state gas sensor 104a may also be fabricated using micro-electro-mechanical system (MEMS) techniques and a silicon substrate resulting in a relatively low power consumption and thermal mass with a relatively fast response time.

The platinum heater 210a and platinum temperature sensor 208a shown in FIG. 5 may each have a thickness of 20 nanometers (nm) and may be sputtered onto the substrate 202a and patterned using a first mask 407 followed by a lift off process. A glass layer 406, which may be a high dielectric spin-on glass layer in one embodiment, may be spin coated onto the platinum heater and temperature sensor to serve as an electrical isolation layer. Contacts may be opened by utilizing a second mask 408 and a buffered oxide etch (BOE) process. The gas sensing element 204a may then be disposed on the glass layer 406 using a sol gel process. The gas sensing element 204a may be a gas sensing thin film, e.g., a tin dioxide SnO₂, patterned using a third mask 409. The sensing electrodes 402, 404 may then be deposited by thermal evaporation and patterned by a fourth mask 410 after sintering a surface of the gas sensing element 204a.

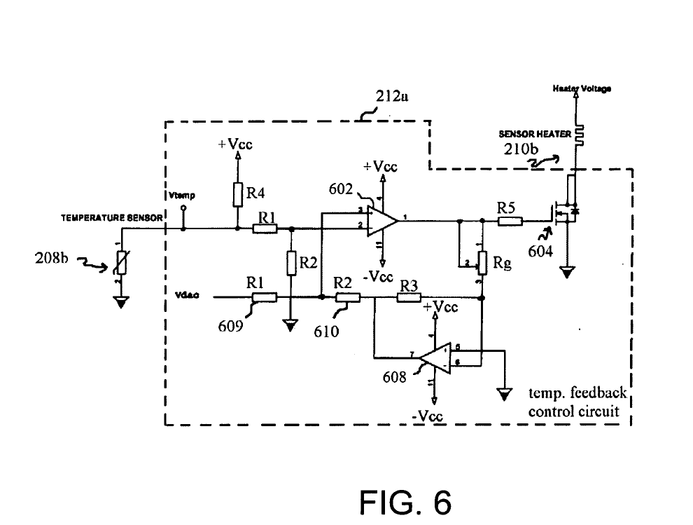

FIG. 6 illustrates one embodiment of a temperature feedback control circuit 212a consistent with the embodiment of FIG. 2 that may be coupled to the temperature sensor 208b and the heater 210b. The temperature sensor 208b may be a platinum temperature sensor that provides a linear change in resistance associated with a change in monitored operating temperature of the associated gas sensing element. The heater 210b may be a platinum heater that may have a heat output level controlled by a current level of the heater. The temperature feedback control circuit 212a may be configured to adjust the current level of the heater in response to the monitored temperature.

The temperature feedback control circuit 212a may include a comparator 602 configured to compare a reference signal at its non-inverting input terminal with a signal at its inverting input terminal representative of the operating temperature as sensed by the temperature sensor 208b. The reference signal may be provided by Vdac and may be reduced by a voltage divider. The comparator 602, which may be an operational amplifier in one embodiment, may provide an output signal in response to this comparison. A control electrode of a transistor 604 may be responsive to the output signal from the comparator 602 to adjust a current level through the heater 210b to thereby control the heat output from the heater 210b. The transistor 604 may be any variety of transistors such as a metal oxide semiconductor field effect transistor (MOSFET) having its gate electrode responsive to the output signal from the comparator 602.

If the monitored operating temperature decreases compared to the desired operating temperature (e.g., which may be caused by a drop in the ambient temperature), the comparator 602 may provide a signal to the control electrode of transistor 604 to cause the transistor 604 to allow an increase in the current level of the heater 210b. Therefore, the heater 210b can provide additional heat output to drive the decreased operating temperature of the gas sensing element back towards the desired operating temperature. If the monitored operating temperature increases compared to the desired operating temperature (e.g., which may be caused by an increase in the ambient temperature), the comparator 602 may provide a signal to the control electrode of transistor 604 to cause the transistor 604 to decrease the current level of the heater 210b. Therefore, the heater would decrease its heat output to drive the increased operating temperature back towards the desired operating temperature.

The temperature feedback control circuit 212a may be designed with a relatively high open loop gain in order to have a relatively fast response time to quickly drive the operating temperature to the desired operating temperature. Gain control components such as comparator 608 and resistors Rg, R1 609, R2 610, and R3 may provide gain control for the circuit 212a. The resulting open loop gain may be as detailed in equation (1) where V₀ is the output voltage of the comparator 602.

$$Vo = \frac{{R}_{2} {R}_{g}}{{R}_{1} {R}_{3}} ( {V}_{temp} - {V}_{DAC} ) , -> gain = \frac{{R}_{2} {R}_{g}}{{R}_{1} {R}_{3}} \qquad ( 1 )$$

In one embodiment, resistor Rg may be 25 kilo-ohms (kΣ), resistor R1 609 may be 10 kΣ, resistor R2 610 may be 50 kΣ, and resistor R3 may be 50 kΣ resulting in a open loop gain of 2.5. The other R1 resistor may also be 10 kΣ and the other R2 resistor may also be 50 kΣ while the R4 resistor may be 680Σ and the R5 resistor may be 100 kΣ in this embodiment. Furthermore, with a MOSFET for transistor 604, at a gate voltage of 3.61 volts, the transconductance of the MOSFET may be 50 siemens. In general, a relatively high transconductance and open loop gain will result in less of a difference between the controlled operating temperature and the desired operating temperature of the gas sensing element.

The temperature sensor 208b may have a calculated resolution based on the value of Vcc, resistor R4, and an assumed resistance of the temperature sensor 208b at the desired operating temperature. If Vcc is +15 volts, resistor R4 is 680Σ, and the resistance of the temperature sensor 208b at the desired operating temperature is 240Σ, the calculated resolution of the temperature sensor may be 16.3 millivolts (mV)/Σ. If the thermal coefficient a of the temperature sensor 208b is equal to 3.9×10⁻³% per degree C./Σ, then 1 degree Celsius of temperature change will cause 0.936Σ change in the resistance of the temperature sensor and thus a 15.25 mV change for the temperature sensor.

In designing the temperature feedback control circuit 212a, the desired operating temperature and the desired power consumption of the heater 210b can be taken into consideration in selection of various components. An approximate heater current level to produce sufficient heat to maintain the sensing element at the desired operating temperature given an average expected ambient temperature can also be taken into consideration. Finally, the desired control voltage level for transistor 604 and the desired input voltage differential to the comparator 602 can also be taken into consideration

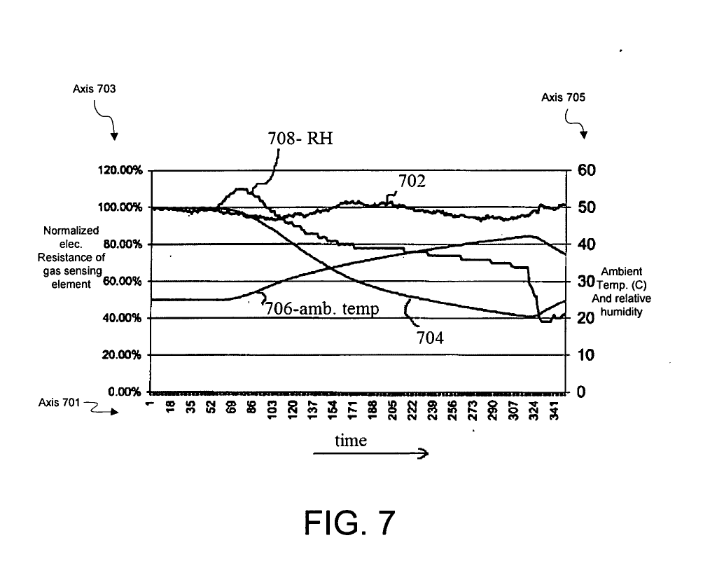

FIG. 7 illustrates the change in a baseline resistance of the gas sensing element in clean air as ambient temperature and relative humidity change over time. Axis 701 represents time and numbers 1 to 341 represent various sampling times taken at a 3 second sampling time interval. Axis 703 represents the electrical resistance of the gas sensing element normalized to 100% at the start of the sampling. Axis 705 represents both temperature in Celsius and relative humidity.

Plot 702 illustrates variations in the electrical resistance of the gas sensing element having feedback temperature control and a temperature feedback control circuit consistent with the embodiment of FIG. 6. In contrast, plot 704 illustrates variations in the electrical resistance of the gas sensing element not having any feedback temperature control. Plot 706 illustrates changes in ambient temperature over time and plot 708 illustrates changes in relative humidity over time.

With the detailed changes in ambient temperature and relative humidity, the variations in the electrical resistance of the sensing element with feedback temperature control as illustrated by plot 702 varied only within about ±5% of its baseline resistance level. With the same detailed changes in ambient temperature and relative humidity, the variations in the electrical resistance of the gas sensing element without feedback temperature control as illustrated by plot 704 varied by as much as 50% from the baseline resistance level at the start of the sampling.

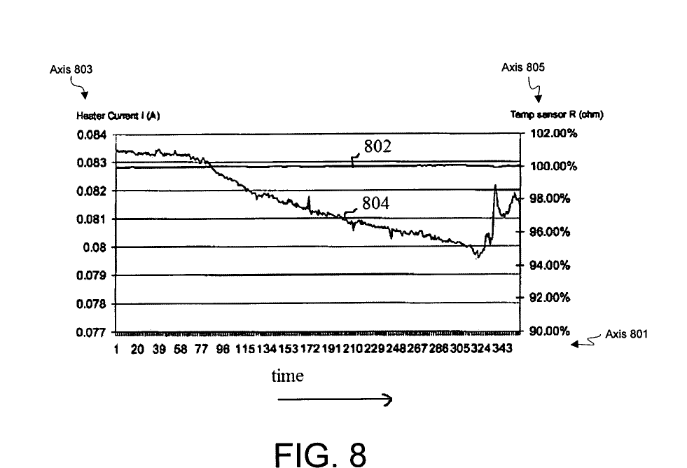

FIG. 8 details the change in the resistance of the platinum temperature sensor 208b of FIG. 6 as well as the change in heater current over the same ambient temperature and relative humidity conditions as illustrated in FIG. 7. Axis 801 represents the time sampling intervals consistent with FIG. 7. Axis 803 represents the heater current in amperes of the heater 210b of FIG. 6. Axis 805 represents the normalized resistance of the platinum temperature sensor 208b of FIG. 6.

Advantageously, plot 802 is relatively constant over the sampling time interval indicating that the sensed operating temperature of the gas sensing element by the platinum temperature sensor 208b remained relatively constant due to the temperature feedback control. Plot 804 illustrates the change in the heater current level. When the ambient temperature as represented by plot 706 remained relatively constant, the heater current also remained relatively constant between 83 and 84 milli-amperes (mA). As the ambient temperature increased, the temperature feedback control circuit 212a reduced the heater current level in order to decrease the heat output provided by the heater 210b. As the ambient temperature decreased after about the 330^{th} sampling time interval, the temperature feedback control circuit 212a increased the heater current level in order to increase the heat output provided by the heater 210b. The change in heater current levels then changes the heat output of the heater 210b in order to effectively drive the operating temperature of the gas sensing element to the desired operating temperature as is evidenced by the relatively constant plot 802.

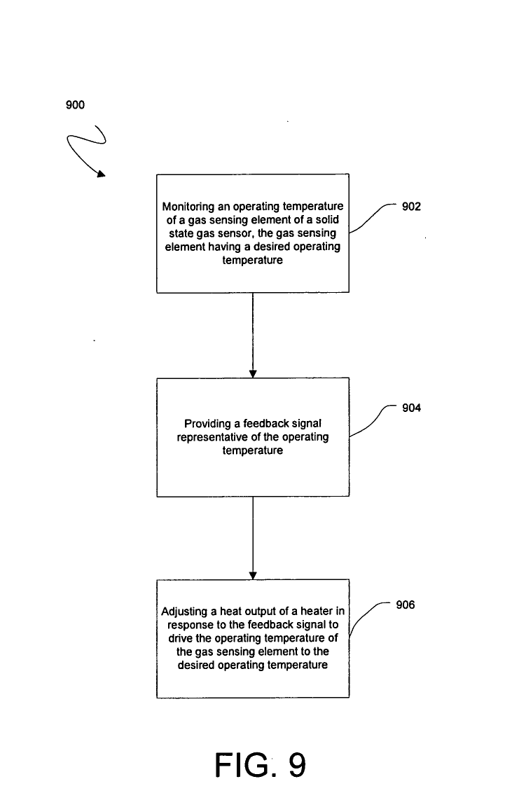

FIG. 9 is a flow chart of operations 900 consistent with an embodiment. Operation 902 may include monitoring an operating temperature of a gas sensing element of a solid state gas sensor, the gas sensing element having a desired operating temperature. Operation 904 may include providing a feedback signal representative of the operating temperature. Finally, operation 906 may include adjusting a heat output of a heater in response to the feedback signal to drive the operating temperature of the gas sensing element to the desired operating temperature.

In summary, one embodiment may include a solid state gas sensor. The sensor may include a gas sensing element having a desired operating temperature. The gas sensing element may be coupled to a substrate. The sensor may further include a temperature sensor coupled to the substrate and configured to sense an operating temperature of the sensing element and provide a feedback signal representative of the operating temperature. The sensor may further include a heater having a heat output. The heater may be responsive to the feedback signal to adjust the heat output to drive the operating temperature to the desired operating temperature.

Another embodiment may include a detector. The detector may include a solid state gas sensor configured to detect a concentration of a gas in air monitored by the detector. The solid state gas sensor may include a gas sensing element having a desired operating temperature. The gas sensing element may be coupled to a substrate. The solid state gas sensor may further include a temperature sensor coupled to the substrate and configured to sense an operating temperature of the sensing element and provide a feedback signal representative of the operating temperature. The solid state gas sensor may further include a heater having a heat output. The heater may be responsive to the feedback signal to adjust the heat output to drive the operating temperature to the desired operating temperature. The detector may further include an alarm configured to activate when a concentration of the gas in the air exceeds a threshold value.

Advantageously, a solid state gas sensor consistent with embodiments herein may be temperature compensated to drive the operating temperature of the gas sensing element of the solid state gas sensor to a desired operating temperature. As such, the actual operating temperature may be maintained within a close tolerance level of the desired operating temperature despite changes in ambient temperature about the solid state gas sensor. The baseline electrical resistance of the gas sensing element in the presence of clean air therefore also advantageously remains relatively constant. The precision of the solid state gas sensor therefore remains high over a range ambient temperatures and relative humidity levels that may otherwise adversely affect the operating temperature of the sensing element.

A temperature feedback control circuit consistent with an embodiment may be designed with a large open loop feedback gain in order to quickly drive the sensed operating temperature to the desired operating temperature. The circuit may also be constructed at a reasonably low cost. Improved precision of the solid state gas sensor when used in a detector may reduce the amount of detector false alarms that may otherwise occur under similar operating conditions. There is also no need to develop a resistance-temperature curve to perform a conventional compensation approach for a solid state gas sensor.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Other modifications, variations, and alternatives are also possible. Accordingly, the claims are intended to cover all such equivalents.

What is claimed is:

1. A solid state gas sensor comprising:
a gas sensing element having a desired operating temperature, said gas sensing element coupled to a substrate;
a temperature sensor coupled to said substrate and configured to sense an operating temperature of said gas sensing element and provide a feedback signal representative of said operating temperature; and
a heater having a heat output, said heater responsive to said feedback signal to adjust said heat output to drive said operating temperature toward said desired operating temperature.

2. The solid state gas sensor of claim 1, wherein said heat output of said heater is adjusted by varying a heater current level of said heater.

3. The solid state gas sensor of claim 2, further comprising a temperature feedback control circuit coupled to said temperature sensor and said heater, said temperature feedback control circuit comprising a comparator to compare a first signal representative of said feedback signal with a reference signal and provide an output signal representative of a difference between said feedback signal and reference signal, said heater configured to adjust said heat output of said heater in response to said output signal.

4. The solid state gas sensor of claim 3, wherein said temperature feedback control circuit further comprises a transistor having a control electrode, said control electrode responsive to said output signal from said comparator to adjust a current level of said heater to adjust said heat output of said heater.

5. The solid state gas sensor of claim 1, wherein said temperature sensor comprises a platinum temperature sensor and said heater comprises a platinum heater.

6. The solid state gas sensor of claim 1, wherein said desired operating temperature is between 100 and 400 degrees Celsius.

7. A detector comprising:
a solid state gas sensor configured to detect a concentration of a gas in air monitored by said detector, said solid state gas sensor comprising a gas sensing element having a desired operating temperature, said gas sensing element coupled to a substrate, said solid state gas sensor further comprising a temperature sensor coupled to said substrate and configured to sense an operating temperature of said gas sensing element and provide a feedback signal representative of said operating temperature, said solid state gas sensor further comprising a heater having a heat output, said heater responsive to said feedback signal to adjust said heat output to drive said operating temperature toward said desired operating temperature; and
an alarm configured to activate when a concentration of said gas in said air exceeds a threshold value.

8. The detector of claim 7, wherein said heat output of said heater is adjusted by varying a heater current level of said heater.

9. The detector of claim 8, wherein said solid state gas sensor further comprises a temperature feedback control circuit coupled to said temperature sensor and said heater, said temperature feedback control circuit comprising a comparator to compare a first signal representative of said feedback signal with a reference signal and provide an output signal representative of a difference between said feedback signal and reference signal, said heater configured to adjust said heat output of said heater in response to said output signal.

10. The detector of claim 9, wherein said temperature feedback control circuit further comprises a transistor having a control electrode, said control electrode responsive to said output signal from said comparator to adjust a current level of said heater to adjust said heat output of said heater.

11. The detector of claim 7, wherein said temperature sensor comprises a platinum temperature sensor and said heater comprises a platinum heater.

12. The detector of claim 7, wherein said desired operating temperature is between 100 and 400 degrees Celsius.

13. A method comprising:
monitoring an operating temperature of a gas sensing element of a solid state gas sensor, said gas sensing element having a desired operating temperature;
providing a feedback signal representative of said operating temperature; and
adjusting a heat output of a heater in response to said feedback signal to drive said operating temperature of said gas sensing element toward said desired operating temperature.

14. The method of claim 13, further comprising adjusting said heat output of said heater by controlling a heat current level of said heater.

15. The method of claim 13, wherein said temperature sensor comprises a platinum temperature sensor and said heater comprises a platinum heater.

16. The method of claim 13, wherein said desired operating temperature is between 100 and 400 degrees Celsius.
